(19) United States
(12) Patent Application Publication
(10) Pub. No.: US 2025/0116155 A1
(43) Pub. Date: Apr. 10, 2025

(54) Animal Rolling Door

(71) Applicant: Frusun Petlove LLC, Sheridan, WY (US)

(72) Inventor: Shidong Deng, Shenzhen (CN)

(21) Appl. No.: 18/377,838

(22) Filed: Oct. 9, 2023

(51) Int. Cl. E06B 9/15; E06B 9/72

(52) U.S. Cl. CPC E06B 9/15; E06B 9/72

(57) ABSTRACT

This present invention is an animal rolling door, which comprises a door frame, a rolling door body, a shell arranged on the door frame and a driving motor which includes a supporting frame, a driving motor, a transmission shaft and a operating handle. A winding component and a external connecting part is arranged on the transmission shaft; a hole is arranged on the shell for the external connecting part to penetrate to outside. The animal rolling door provided by the present invention capable of achieving to open and close the animal rolling door automatically or manually, which greatly improves the reliability and convenience of use of the animal rolling door.

### FIELD OF THE INVENTION

The present invention belongs to automatic door technical field, in particular to an animal rolling door.

### BACKGROUND OF THE INVENTION

We usually keep animals like poultry, livestock and so on indoors such as barns, fences or special cages. However, animals cannot be kept in a closed space all the time. For their health, the door needs to be opened frequently or regularly to allow them to move freely in an open space. When the breeder works out or cannot perform this work because of travelling, a safe device that can automatically perform operations on behalf of the breeder is needed.

Typical self-actuating safe devices on the market at present are automatic or motorized doors. Although the automatic door capable of opening or closing automatically, it is not always reliable just by electric driving work. For example, animals will be stuck indoors for long periods of time when the electric mechanism cannot drive the automatic door opening and closing due to battery exhausted or circuit failure.

### DETAILED DESCRIPTION

The purpose of the present invention is to provide an animal rolling door which capable of opening or closing the animal rolling door manually when battery exhausted or circuit failed, thereby improve the reliability and the convenience of use of the animal rolling door.

In order to achieve the above purpose, the present invention adopts the following technical resolutions: proving an animal rolling door which comprises a door frame, a rolling door body, a shell with inner cavity arranged on the top of door frame and a driving mechanism arranged in the shell, which is used to drive the rolling door body to do lifting movement along with the door frame. The driving mechanism comprises a supporting frame installed in the shell and a driving motor arranged on the supporting frame, a transmission shaft fixedly connected to the driving motor and an operating handle fixedly connected to the transmission shaft. The transmission is provided with a winding component for winding the rolling door body and an external connecting part used to fixedly connect with the operating handle; the shell is provided with a hole for the external connecting hole to penetrate to outside.

In an embodiment, limit guide rails are arranged on opposite sides of the door frame to limit the moving direction of the rolling door body.

In an embodiment, a fixed component detachable connected to the rolling door body is arranged on the winding component.

In an embodiment, the driving mechanism further comprises a rolling bearing arranged between the gap of the transmission shaft and the inner wall of the hole.

In an embodiment, the animal rolling door further comprises a on-off switch electrically connected to the driving motor, which is configured as a temperature and humidity sensor, a rain sensor, a infrared sensor, a microwave sensor, a wind speed sensor or a voice control sensor.

In an embodiment, the animal rolling door further comprises an alarming component, which comprises an alarming light and/or an alarming speaker, is electrically connected with the on-off switch.

In an embodiment, the animal rolling door further comprising a light sensor, which is electrically connected with the driving motor, is arranged on the external surface of the shell.

In an embodiment, the animal rolling door further comprising a battery in the shell to electrically connect with the driving motor and a solar panel to electrically connect with the battery.

In an embodiment, luminous components are arranged on the both sides of the door frame along with height direction of the door frame.

In an embodiment, the surface of the door frame is recessed inward to form an installation groove for installing the luminous components; the front side of the installation groove is provided with an opening towards to the outside; the luminous components are arranged in the installation groove and exposed to the outside through the opening.

The beneficial effect of an animal rolling door provided by the present invention is that, compared with prior art, the animal rolling door of the present invention comprises a door frame; a rolling door body; a shell with inner cavity arranged on the door frame; a driving mechanism arranged in the shell and used to drive the rolling door body to do lifting movement along with the door frame, which comprises a supporting frame installed in the shell; and a driving motor arranged on the supporting frame; a transmission shaft fixedly connected to the driving motor; and an operating handle fixedly connected to the transmission shaft; the transmission shaft is provided with a winding component used to wind the rolling door body and an external connecting part used to fixedly connect the operating handle; the shell is provided with a hole for the external connecting part to penetrate to outside. The driving motor is installed in the default position in the shell by the supporting frame of the driving mechanism; the winding component of the transmission shaft is fixedly connected to the rolling door body; the driving motor is used to drive the transmission shaft to rotate and drive the rolling door body to automatically rewind or unwind, thereby achieving the purpose of automatically opening or closing the animal rolling door. At the same time, the external connecting part of the transmission shaft is set through the hole on the shell and is fixedly connected to the operating handle. When the battery exhausted or circuit failed of the driving motor, the operating handle is used to drive manually by the breeder to dive the transmission shaft to rotate, thereby driving the rolling door body to rewind or unwind, and achieving the purpose of opening and closing the animal rolling door manually. Therefore, the present invention capable of automatically opening or closing the animal rolling door when the power supply is normal, while the battery exhausted or the circuit failed, the animal rolling door can also be opened or closed manually, which greatly improves the reliability and convenience of use of the animal rolling door.

### DESCRIPTION OF THE DRAWINGS

In order to more clearly illustrate the technical solutions of the embodiment or the prior art of the present invention, a brief introduction of the drawings that need to be used in the embodiment or the description of the prior art will be given below, apparently, the drawings in the following description are only some embodiments of the present invention, for those of general person skilled in the art, on the basis of no inventive efforts, other drawings can also be obtained based on these drawings.

FIG. 1 is a first schematic diagram of three-dimensional structure of animal rolling door provided by the embodiment of the present invention;

FIG. 2 is a left side schematic diagram thereof;

FIG. 3 is a second schematic diagram of three-dimensional structure thereof;

FIG. 4 is a third schematic diagram of three-dimensional structure thereof.

Reference signs in the drawings: 1—door frame; 11—limit guide rail; 2—rolling door body; 3—shell; 4—supporting frame; 5—driving motor; 6—transmission shaft; 61—winding component; 7—operating handle; 71—anti—slip component; 8-rolling bearing.

### Detailed Description of the Preferred Embodiments

In order to make the technical problems to be solved, technical solutions and beneficial effects of the present invention clearer, the present invention will be further described in detail below with reference to the drawings and embodiments. It should be understood that the specific embodiments described here are only used to explain the present invention and are not intended to limit the present invention.

It should be noted that when an element is called as being “fixed to” or “arranged on” another element, it can be directly on the other element or indirectly on the other element. When an element is called as being “connected to” another element, it can be directly connected to the other element or indirectly connected to the other element.

It should be understood that the terms “length”, “width”, “top”, “bottom”, “front”, “rear”, “left”, “right”, “vertical”, “horizontal”, “top”, “bottom”, “inside” and “outside” which indicates the orientations or positional relationships are based on the orientations or positional relationships shown in the drawings. They are only for facilitating describing the present invention and simplifying the description, rather than indicating or implying that the device or component must have a specific orientation, construct and operate in a specific orientation, therefore, it understood as a limitation of the present invention.

In addition, the terms “first” and “second” are used for descriptive purposes only and cannot be understood as indicating or implying relative importance or implicitly indicating the quantity of indicated technical features. Therefore, a feature defined as “first” and “second” may explicitly or implicitly include one or more of these features. In the description of the present invention, “multiple” means two or more, unless otherwise specifically defined.

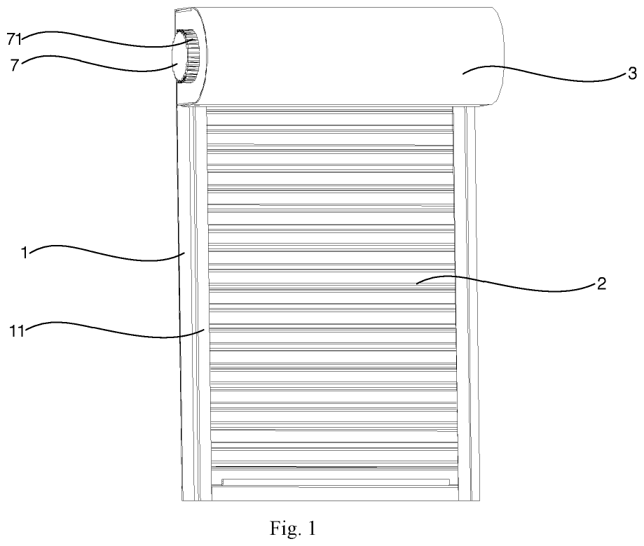

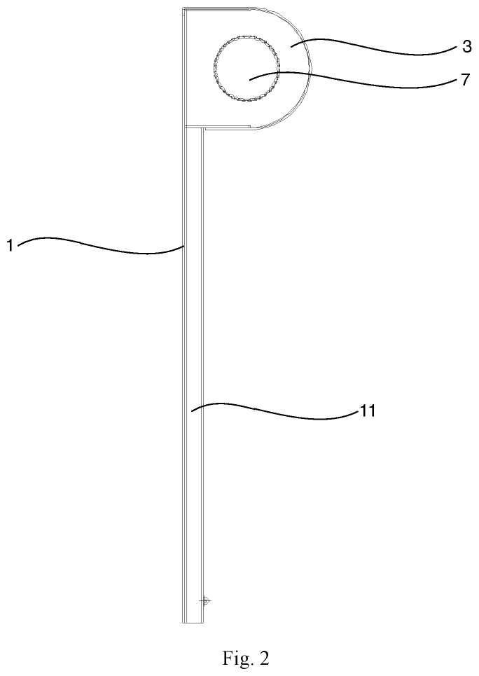

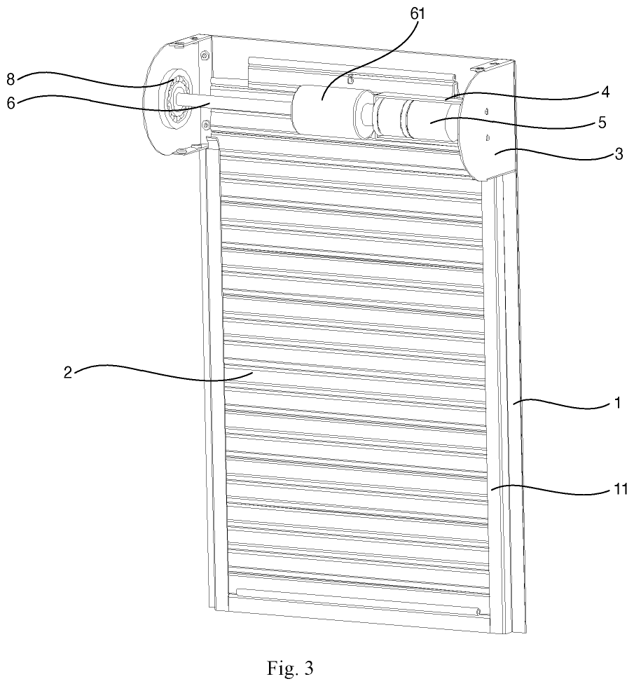

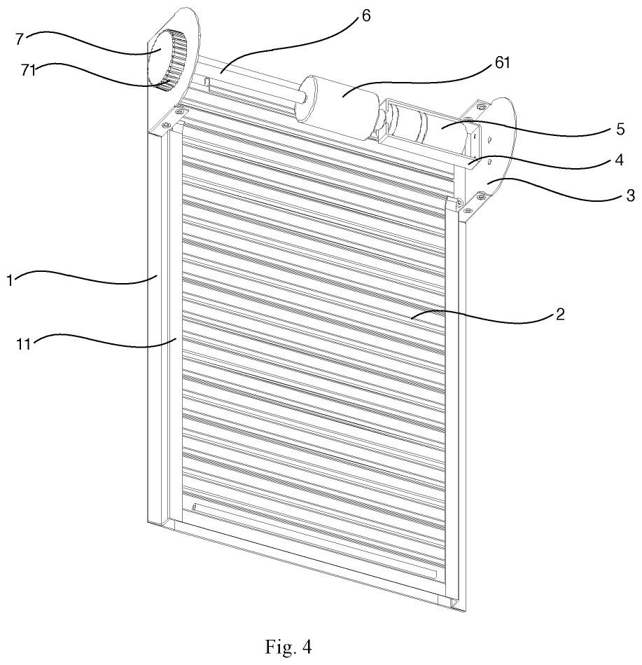

Please refer to FIG. 1 to FIG. 4, an animal rolling door provided by the embodiment of the present invention, which comprises a door frame 1; a rolling door body 2; a shell 3 with inner cavity arranged on the door frame 1; a driving mechanism arranged in the shell 3 and used to drive the rolling door body 2 to do lifting movement along with the door frame 1, which comprises a supporting frame 4 installed in the shell 3; and a driving motor 5 arranged on the supporting frame 4; a transmission shaft 6 fixedly connected to the driving motor 5; and an operating handle 7 fixedly connected to the transmission shaft 6; the transmission shaft 6 is provided with a winding component 61 used to wind the rolling door body 2 and an external connecting part used to fixedly connect the operating handle 7; the shell 3 is provided with a hole for the external connecting part to penetrate to outside. The driving motor 5 is installed in the default position in the shell 3 by the supporting frame 4 of the driving mechanism; the winding component 61 of the transmission shaft 6 is fixedly connected to the rolling door body 2; the driving motor 5 is used to drive the transmission shaft 6 to rotate and drive the rolling door body 2 to automatically rewind or unwind, thereby achieving the purpose of automatically opening or closing the animal rolling door. At the same time, the external connecting part of the transmission shaft 6 is set through the hole on the shell 3 and is fixedly connected to the operating handle. When the battery exhausted or circuit failed of the driving motor 5, the operating handle 7 is used to drive manually by the breeder to dive the transmission shaft 6 to rotate, thereby driving the rolling door body 2 to rewind or unwind, and achieving the purpose of opening and closing the animal rolling door manually. Therefore, the present invention capable of automatically opening or closing the animal rolling door when the power supply is normal, while the battery exhausted or the circuit failed, the animal rolling door can also be opened or closed manually, which greatly improves the reliability and convenience of use of the animal rolling door.

Please refer to FIG. 1 to FIG. 3, as a specific embodiment of an animal rolling door provided in the present embodiment, the opposite sides of a door frame 1 of the animal rolling door are provided with limit guide rails 11 for limiting the moving direction of a rolling door body 2, thereby, during the winding or unwinding process, the rolling door body 2 capable of moving up and down relative to the door frame 1 according to the moving direction set by the limit guide rails 11. On the one hand, this enables the sliding process of the rolling door body 2 more stable. On the other hand, this enables the rolling door body 2 to be closed more tightly in the unwinding state, thereby improving the reliability and structural stability of the animal rolling door.

Optionally, luminous components are provided on both sides of a door frame 1 along the height direction thereof. By adding luminous components on both sides of the door frame 1, a luminous cue light is formed to attract animals back or assist animals to find the way back in the dark. Optionally, the surface of the door frame 1 is recessed inward to form an installation groove for installing luminous components. The front side of the installation groove is provided with an opening that opens outward. The luminous components are arranged in the installation groove and exposed to the outside through the opening. The door frame 1 is provided with an installation groove for installing the luminous components, so that the luminous components can be firmly and stably installed on the door frame 1, and can be prevented from being damaged by animals during use at the same time, which plays a protective role to the luminous components. Optionally, the luminous components may be in the shape of a long tube, with LED lamp beads arranged inside. The cross-section of the installation groove is circular, and the luminous components are embedded in the installation groove.

Optionally, the connection method between a winding component 61 of a transmission shaft 6 and a rolling door body 2 is not limited here, and a detachable connection or a non-detachable connection can be used; Optionally, the connection method between the winding component 61 of the transmission shaft 6 and the rolling door body 2 is a detachable connection, the winding component 61 is provided with a fixed structure for detachably connecting the rolling door body 2, which facilitating the user to replace the damaged parts and facilitates them to assemble and disassemble when the rolling door body 2 or the driving mechanism works abnormally, thereby helping reduce the user's cost and making the animal rolling door more convenient during transportation. The specific structure of the fixed structure on the winding component 61 is not limited here; the fixed structure on the winding component 61 for detachably connecting the rolling door body 2 can be a connecting rod or a locking bolt; when the fixed structure is a connecting rod, the fixed structure is fixed on the winding component 61 of the transmission shaft 6, and a connection hole is arranged on the top of the rolling door body 2 for the fixed structure to pass through, that is, the rolling door body 2 can be detachably connected on the transmission shaft 6, thereby achieving the rolling door body 2 is driven by the transmission shaft 6 to rewind or unwind; when the fixed structure is a locking bolt, the winding component 61 and the rolling door body 2 are both provided with threaded holes for threading the fixed structure, that is, the rolling door body 2 is detachably connected on the transmission shaft 6, so that the transmission shaft 6 drives the rolling door body 2 to wind or unwind.

Optionally, the animal rolling door further includes a light sensor arranged on the outer surface of a shell 3. The light sensor is electrically connected to a driving motor 5; a limit rod is arranged on the lower edge of the rolling door body 2. When the light sensor detects a light signal in the morning, the control unit electrically connected to the light sensor will issue an opening instruction to the driving motor 5. After the driving motor 5 is powered on, it can drive the rolling door body 2 to rewind. When the animal rolling door is opened to the maximum, the limit rod limits the rolling door body 2 to roll continually, the movement of the rolling door body 2 is blocked, and the resistance to the driving motor 5 increases, at this time, the power supply current of the driving motor 5 increases, and the control unit issues an instruction to disconnect the power supply to the driving motor 5 thereby achieving the purpose of limited stop; When no light is detected the light sensor at night, the control unit will issue a closing instruction to the driving motor 5. After the driving motor 5 is powered on, it can drive the rolling door body 2 to unwind. When the animal rolling door is closed, the limit rod is pressed against the ground. As a result, the movement of the rolling door body 2 is blocked, and the driving motor 5 encounters greater resistance, at this time, the power supply current of the driving motor 5 increases, and the control unit issues an instruction to disconnect the power supply to the driving motor 5.

Optionally, a animal rolling door further includes an on-off switch electrically connected to the driving motor 5. The on-off switch can be configured as a temperature and humidity sensor, a rain sensor, an infrared sensor, a microwave sensor, a wind speed sensor or a sound control sensor to control the driving motor 5 on or off, and drive the rolling door body 2 to slide along limit guide rails 11 on both sides of a door frame 1. The on-off switch can also be configured to control the driving motor 5 on or off according to the remote wireless signal, thereby driving the rolling door body 2 sliding along the limit guide rails on the two sides of the door frame 1. Optionally, the animal rolling door further includes an alarming component electrically connected to the on-off switch. When the on-off switch controls the driving motor 5 to start and the driving motor 5 drives the rolling door body 2 to rewind or unwind, the alarming component starts the operation and sends out an alarm signal to prompt the breeder that the driving motor 5 of the animal rolling door is working; optionally, the alarming component includes an alarming light and/or an alarming speaker, which prompts the breeder through the flashing of the alarming light and/or the sound of the alarming speaker.

Optionally, the animal rolling door further includes a battery arranged in a shell 3 and a solar panel electrically connected to the battery. The battery, which is electrically connected to the driving motor 5, is arranged in the inner cavity of the shell 3. The solar panel is electrically connected to the battery which is electrically connected to the driving motor 5. The solar panel is configured to convert light energy into electrical energy and transmit it to the battery. The battery is configured to store the electric energy from the solar panel and provide power to the driving motor 5. The battery can store electric energy on a sunny day, thereby preventing the driving motor 5 from being unable to work due to lack of electric energy without sunlight.

Optionally, a driving mechanism further includes a rolling bearing 8 sleeved on a transmission shaft 6. The rolling bearing 8 is arranged in the gap between the transmission shaft 6 and the inner wall of the through hole. A rolling bearing 8 is arranged in the gap to reduce the friction between the transmission shaft 6 and the shell 3 during rolling, thereby reducing the kinetic energy loss of the driving motor 5, and it is more labor-saving when the operator manually turns the operating handle 7, which is beneficial to improve user experience. Optionally, the outer surface of the operating handle 7 is provided with an anti-slip component 71, which can increase the friction between the operator's palm and the surface of the operating handle 7, facilitating the operator to manually turn the operating handle 7, which is beneficial to improve user experience; the specific structure of the anti-slip component 71 on the outer surface of the operating handle 7 is not limited here; optionally, the anti-slip component 71, which is arranged on the outer surface of the operating handle 7, can be an anti-slip protrusion, an anti-slip groove, an anti-slip rubber strips or others.

The above described embodiments are only preferred embodiments of the present embodiment and are not intended to limit the present embodiment. Any modifications, equivalent substitutions and improvements made within the spirit and principles of this embodiment shall be included in the protection scope of the present embodiment.

1. A animal rolling door, characterized in comprising a door frame 1; a rolling door body 2; a shell 3 arranged on the door frame 1; a driving mechanism arranged on the shell 3 and used to drive the rolling door body 2 to do lifting movement along with the door frame 1, which includes a supporting frame 4 installed in the shell 3; a driving motor arranged on the supporting frame 4; a transmission shaft 6 fixedly connected to the driving motor 5; an operating handle 7 fixedly connected to the transmission shaft 6; the transmission shaft 6 is provided with a winding component 61 used to wind the rolling door body 2 and an external connecting part used to fix and connect the operating handle 7; the shell 3 is provided with a hole for the external connecting part to penetrate to outside.

2. The animal rolling door according to claim 1, characterized in that limit guide rails are arranged on opposite sides of the door frame 1 to limit the moving direction of the rolling door body 2.

3. The animal rolling door according to claim 1, characterized in that a fixed component detachably connected to the rolling door body 2 is arranged on the winding component 61.

4. The animal rolling door according to claim 1, characterized in that the driving mechanism further comprises a rolling bearing 8 arranged between the gap of the transmission shaft 6 and the inner wall of the hole.

5. The animal rolling door according to claim 1, characterized in further comprising an on-off switch, which is electrically connected with the driving motor 5, can be configured as a temperature and humidity sensor, a rain sensor, a infrared sensor, a microwave sensor, a wind speed sensor or a voice control sensor.

6. The animal rolling door according to claim 5, characterized in further comprising an alarming component, which includes an alarming light and/or an alarming speaker, is electrically connected with the on-off switch.

7. The animal rolling door according to claim 1, characterized in further comprising a light sensor, which is electrically connected with the driving motor 5, is arranged on the external surface of the shell 3.

8. The animal rolling door according to claim 1, characterized in further comprising a battery in the shell 3 to electrically connect with the driving motor 5 and a solar panel to electrically connect with the battery.

9. The animal rolling door according to claim 1, characterized in that luminous components are arranged on the both sides of the door frame 1 along with height direction of the door frame 1.

10. The animal rolling door according to claim 9, characterized in the surface of the door frame 1 is recessed inward to form a installation groove for installing the luminous components; the front side of the installation groove is provided with an opening towards to the outside; the luminous components are arranged in the installing groove and exposed to the outside through the opening.
